(19) United States
(12) Patent Application Publication
(10) Pub. No.: US 2021/0260424 A1
(43) Pub. Date: Aug. 26, 2021

(54) ROBOTIC FIRE FIGHTER

(71) Applicant: Aussie Challenger Pty Ltd, North Altona (AU)

(72) Inventor: Joseph Paul SCHEMBRI, Point Cook (AU)

(73) Assignee: Aussie Challenger Pty Ltd, North Altona (AU)

(21) Appl. No.: 17/182,515

(22) Filed: Feb. 23, 2021

(30) Foreign Application Priority Data
Feb. 24, 2020 (AU) 2020900522

(51) Int. Cl. A62C 31/28; A62C 27/00; A62C 3/02; G05D 1/00

(52) U.S. Cl. CPC A62C 31/28; G05D 1/0011; A62C 3/0207; A62C 27/00

(57) ABSTRACT

A device for fighting a fire by spreading material such as dirt onto the fire comprising including a rotating drum to collect material into a chamber and a rotating blade to move the material through the chamber and out through a directable chute. A fan assists the material through the chute. The rotating drum includes either mulching blades, hoeing blades or scoops to gather the material. The device is used in conjunction with a motive device such as a tractor or a remotely controlled drive unit.

### FIELD OF THE INVENTION

The present invention relates to firefighting equipment, in particular a robotic fire fighter that uses dirt to extinguish a fire.

### BACKGROUND TO THE INVENTION

Whilst bushfires, or wildfires as they are known in places, have been a perennial problem, their frequency and magnitude have been increasing in recent times due to climate change. With more frequent and larger fires to deal with traditional firefighting practises are struggling to keep pace leading to increased losses of bushland, wildlife, properties and even lives.

The most common approach to putting out fires is to douse the fire with water pumped from a fire truck. This approach has many problems, such as the availability of water, the need to regularly re-fill the fire truck, access to the fire front in remote terrain, and the danger to the fire fighting personnel.

The use of aircraft to fight fires has improved fire fighting efficiency and allows access to otherwise inaccessible terrain. However, aircraft are often unable to operate in thick smoke and still need a readily available supply of water. Aircraft are also expensive to procure and to operate.

Chemical additives are sometimes added to water to act as a fire retardant that can be applied ahead of a fire front. The use of such chemicals is however undesirable due to their environmental impact, both on the immediate region and areas that may receive water runoff.

The object of this invention is to provide a firefighting device to alleviate the above problems, or at least provide the public with a useful alternative.

### SUMMARY OF THE INVENTION

In a first aspect the invention provides a device for fighting a fire comprising a chamber, a rotating drum moving material into the chamber, and a rotating blade assembly within the chamber moving material into a chute to exit the device and onto the fire.

Preferably the firefighting device further comprise a fan to move air through the chute to assist material exiting the device, and the chute is rotatable to direct the material.

The rotating drum may comprise mulching blades, hoe blades or scoops.

Preferably the device further comprises a remote control vehicle to move the device.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 shows a front view of a firefighting device with a single rotating disc according to a preferred embodiment of the invention.

FIG. 2A shows an end view of a rotating drum of the firefighting equipment fitted with hoe blades.

FIG. 2B shows an end view of a rotating drum of the firefighting equipment fitted with mulching blades.

FIG. 2C shows an end view of a rotating drum of the firefighting equipment fitted with scoops.

FIG. 3 shows a cutaway side view of the firefighting device.

FIG. 4 shows a front view of a fire fighting device with two rotating discs.

### DRAWING COMPONENTS

The drawings include the following integers.
10 firefighting device (with single rotating blades and chute)
11 firefighting device with multiple rotating blades and chutes
20 rotating drum
22 hoe blades
24 mulching blades
26 scoops
30 chamber
32 dividing wall
34 bottom plate
36 top plate
40 rotating blade assembly
42 disc
44 blades
50 fan
52 blades
60 chute
62 rotating collar
70 motor
72 gearbox

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

The present invention provides a new paradigm for fighting fires in scrubland or farmland. Instead of dousing the fire with water, the present invention uses dirt or soil to cover a fire. The firefighting device of the invention includes a rotating drum fitted with hoe blades, mulching blades or scoops gathers material and throws it into a chamber with a rotating blade. The blade transports the material to a chute from where it is spread onto a fire, smothering the flames. A fan helps to eject the material. The device may be fitted to existing machinery such as a tractor or bulldozer, or any motive device. Remote control devices can be used to minimise the exposure of operators to fire risk. The device may be operated to extinguish a burning fire or to produce a fire break by breaking down organic fuel loads and covering them with soil. The device may also operate on smouldering ground, effectively turning it over to reduce the risk of flare ups. This greatly reduces the workload in mopping up after a fire.

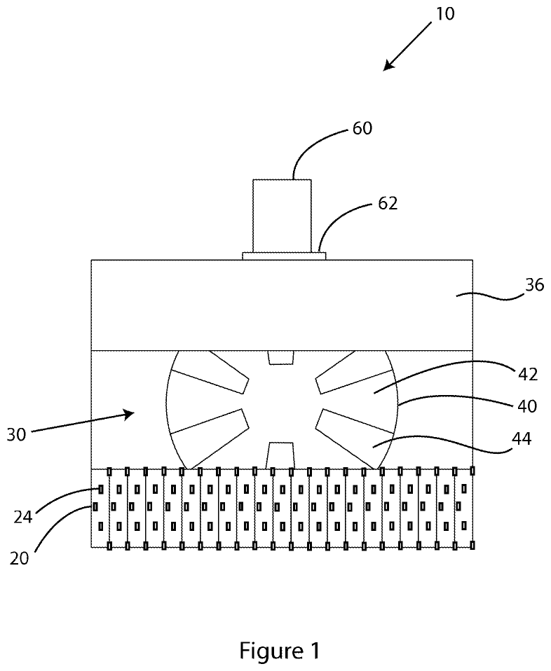

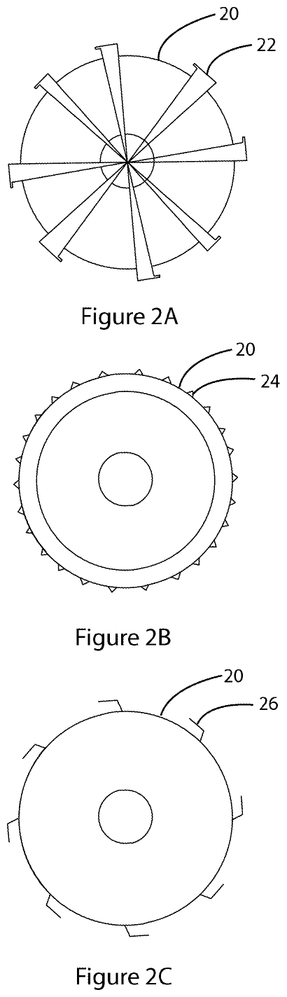

A firefighting device 10 according to a preferred embodiment of the invention is shown from front on in FIG. 1. The firefighting device 10 comprises a rotating drum 20 for moving material into chamber 30. The rotating drum 20 is fitted with a series of implements depending on the ground conditions that the device is operating on. For hard soil hoe blades 22 are fitted, for soil covered with organic material mulching blades 24 are fitted, and for loose or sandy soils scoops 26 are fitted. As the drum 20 rotates the implements 22, 24 or 26 break up the material it encounters and flings it into the chamber 30. FIGS. 2A, 2B and 2C show side view of rotating drums 20 fitted with the various implements. FIG. 2A shows hoe blades fitted, FIG. 2B mulching blades and FIG. 2C scoops. The chamber 30 includes a rotating blade assembly comprising a rotating disc 42 fitted with blades 44. As the disc 42 rotates the blades 44 move the material in the chamber towards the top of the chamber. A shroud (not shown) surrounds the rotating blade assembly to retain the material as it would otherwise be flung from the assembly due to the centripetal force imparted to the material by the high rotational speed of the rotating blade assembly. An opening at the top of the shroud allows the material to be ejected from the chamber into chute 60 and out of the device and onto the fire. The chute 60 is mounted on a rotating collar 62 to allow the material to be directed as desired. A fan (discussed below) helps eject material from the chute.

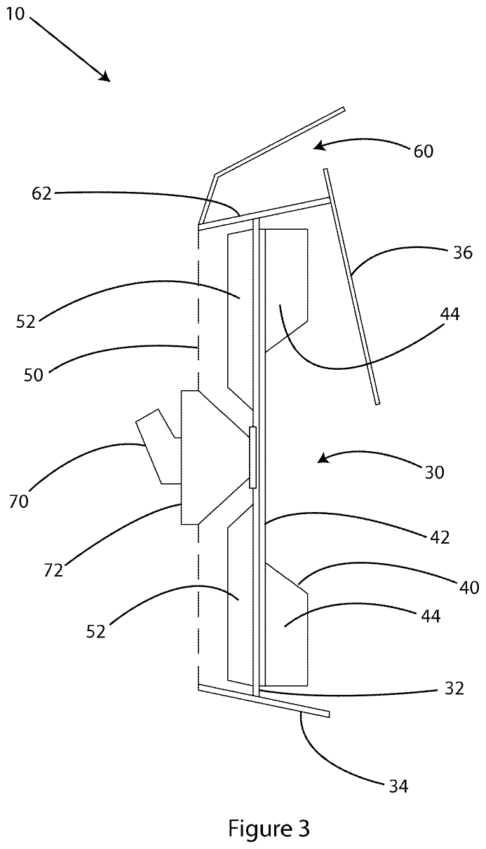

Further detail of the firefighting device 10 can be seen in FIG. 3 which provides a cutaway side view. The chamber 30 includes a bottom plate 34 which may also act to scoop material into the chamber, dividing wall 32 and top wall 36 for retaining material. Not shown is a shroud which surrounds rotating blade assembly 40 mounted against the dividing wall 32. Behind the dividing wall sits a fan 50 comprising blades 52. The fan creates an airstream which passes through chute 60 to expel material in conjunction with the centripetal force imparted by the rotating blade assembly. Power for the fan 50 and blade assembly 40 is provided by motor 70 via gearbox 72. The motor may take any suitable form for example electric, hydraulic, or pneumatic, with electrical, pneumatic or hydraulic power supplied by an external device such as a tractor. The motor 70 may instead be replaced with a mechanical, chain or belt coupling to engage with a PTO (power take off) from a tractor or other suitable device.

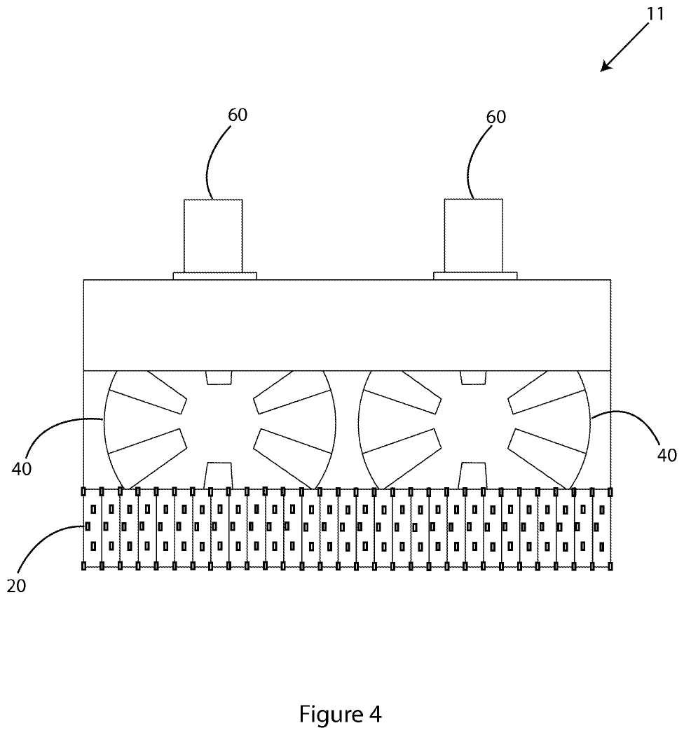

FIG. 4 shows a firefighting device 11 according to a further embodiment of the invention which incorporates two rotating blade assemblies 40 and two chutes 60. A firefighting device with further blade assemblies and chutes is also envisaged by the invention.

The firefighting device 10 has been shown isolated from any motive means. It can readily be mounted on conventional tractors, bulldozers or any other suitable device. In particular the firefighting device can be mounted to a remote controlled vehicle so that the fire crew may be safely located remotely from the fire.

In use the firefighting device 10 may be used to extinguish a burning fire, or prepare a firebreak in front of a fire. The firefighting device may also work on recently burnt ground to minimise the chance of a flare up. The rotating drum 20 used with the firefighting device is chosen according to the terrain present.

In a further application the firefighting device is used in the absence of a fire to break down plant material and combine it with soil. This will allow the plant material to easily decompose and return carbon to the earth ultimately reducing the amount of carbon in the air. This activity can be carried out year round, unlike backburning which can only safely be done at limited times. By reducing fuel loads the need for burn offs is also minimised.

The reader will now appreciate the present invention which provides a firefighting device that can operate without water, allowing fires to be fought in situations previously not possible. Dirt or other material is picked up and spread over the fire to smother it or alternatively spread in front of a fire to make a fire break. By being able to be operated remotely the risk to fire crews is greatly reduced. As well as potentially saving lives in the community by making fire breaks and effectively dealing with fires the device is also beneficial to the environment with its ability to return carbon to the soil.

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A device for fighting a fire comprising a chamber, a rotating drum moving material into the chamber, and a rotating blade assembly within the chamber moving material into a chute to exit the device and onto the fire.

2. The device for fighting a fire according to claim 1, further comprising a fan to move air through the chute to assist material exiting the device.

3. The device for fighting a fire according to claim 1, wherein the chute is rotatable to direct the material exiting the chamber via the chute.

4. The device for fighting a fire according to claim 1, wherein the rotating drum comprises mulching blades.

5. The device for fighting a fire according to claim 1, wherein the rotating drum comprises hoe blades.

6. The device for fighting a fire according to of claim 1, wherein the rotating drum comprises scoops.

7. The device for fighting a fire according to claim 1, further comprising a remote control vehicle to move the device.
